(19) United States
(12) Patent Application Publication
(10) Pub. No.: US 2020/0053395 A1
(43) Pub. Date: Feb. 13, 2020

(54) VIDEO DISTRIBUTION SYSTEM, USER TERMINAL DEVICE, AND VIDEO DISTRIBUTION METHOD

(71) Applicant: Panasonic Intellectual Property Management Co., Ltd., Osaka (JP)

(72) Inventors: Takashi MUKAIYAMA, Kanagawa (JP); Akira HAGIHARA, Kanagawa (JP); Toshiki YAMAGUCHI, Kanagawa (JP); Kohei NAGURA, Kanagawa (JP); Bilguun SAINBAYAR, Kanagawa (JP)

(73) Assignee: Panasonic Intellectual Property Management Co., Ltd., Osaka (JP)

(21) Appl. No.: 16/478,608

(22) PCT Filed: Dec. 19, 2017
(86) PCT No.: PCT/JP2017/045412

§ 371 Date: Jul. 17, 2019

(30) Foreign Application Priority Data
Jan. 20, 2017 (JP) 2017-008318

(51) Int. Cl. H04N 21/218; H04N 21/214; H04N 21/231; H04N 21/234; H04N 21/442; H04N 21/44; H04N 21/6587; H04N 21/4728

(52) U.S. Cl. CPC H04N 21/21805; H04N 21/214; H04N 21/231; H04N 21/4728; H04N 21/44218; H04N 21/44; H04N 21/6587; H04N 21/234

(57) ABSTRACT

A video distribution system that generates a distribution video from a captured video obtained by capturing an event venue and distributes the distribution video to user terminal via a network is provided and includes a camera installed at a predetermined position in the event venue and capturing the event venue in a predetermined direction; a captured video storage accumulating a captured video output from the camera; a video processing computer that cuts out regions respectively corresponding to a plurality of viewpoints with respect to a subject from the captured video, and generates a plurality of distribution videos different in viewpoint; and a video distribution server that distributes the distribution video corresponding to a distribution request to the user terminal device when receiving the distribution request including information on the viewpoint selected by a user from the user terminal device.

### TECHNICAL FIELD

The present disclosure relates to a video distribution system and a video distribution method for generating a distribution video from a captured video obtained by capturing an event venue and delivering the distribution video to a user terminal device via a network, and a user terminal device that receives a distribution video to be distributed from a video distribution device via a network and displays the distribution video.

### BACKGROUND ART

In recent years, an image distribution service has been widely used to distribute a video obtained by capturing a venue, where various events of a concert and the like are held, by a camera, from a video distribution server to a user terminal. In such a video distribution service, there is a possibility that a favorite person is reflected on an edge of a video or hidden behind another person, so that it is difficult to view the favorite person. Therefore, there is a demand for a user to view the video that matches his/her demand.

In the related art, there is known a technology in which in response to the demand of the user in such a video distribution service, a plurality of cameras are installed so that a person can be captured at the same time from different directions, and the user can select a camera, so that videos with different capturing angles can be viewed (see PTL 1). In addition, there is known a technology in which an authority to operate a camera is given to a specific user and a capturing state such as a camera posture or a viewing angle is remotely controlled by an operation of the user (see PTL 2).

### CITATION LIST

### Patent Literature

PTL 1: Japanese Patent Unexamined Publication No. 2011-103522

PTL 2: Japanese Patent Unexamined Publication No. 2003-339038

### SUMMARY OF THE INVENTION

In the technology disclosed in PTL 1, the user can view a video captured from a desired direction. However, for example, there is a problem that even if there is a demand for viewing an attention portion in the video in a close view, such as a face of a favorite person, a video matching such a demand cannot be displayed. In the technology disclosed in PTL 2, there is a problem that a specific user having authority to operate the camera can view a video matching his/her demand, but all users cannot view an image matching his/her demand.

A main object of the present disclosure is to provide a video distribution system, a user terminal device, and a video distribution method that efficiently generate various videos matching diverse demands of a user and enable the user to view a video matching the demand of the user his/herself.

A video distribution system of the present disclosure that generates a distribution video from a captured video obtained by capturing an event venue and distributes the distribution video to a user terminal device via a network, the system including: a camera that is installed at a predetermined position of the event venue and captures the event venue in a predetermined direction; a captured video storage that accumulates the captured video output from the camera; a video processing computer that cuts out regions respectively corresponding to a plurality of viewpoints with respect to a subject from the captured video, and generates a plurality of distribution videos different in viewpoint; and a video distribution server that distributes the distribution video corresponding to a distribution request to the user terminal device when receiving the distribution request including information on the viewpoint selected by a user from the user terminal device.

A user terminal device of the present disclosure that receives a distribution video distributed from a video distribution device via a network and displays the distribution video, the device including: an operation input unit that performs an operation of selecting an event desired to be viewed and a viewpoint with respect to a subject by a user; a transmitter that transmits a distribution request including information on the event and the viewpoint which are selected by the user to the video distribution device; a receiver that receives the distribution video corresponding to the distribution request distributed from the video distribution device; and a processor that controls reproduction of the received distribution video and displays the distribution video on a video display unit.

A video distribution method of causing an information processing device to perform a process of generating a distribution video from a captured video obtained by capturing an event venue and distributing the distribution video to a user terminal device via a network, the method including: cutting out regions respectively corresponding to a plurality of viewpoints with respect to a subject from the captured video, and generating a plurality of distribution videos different in viewpoint; and distributing the distribution video corresponding to a distribution request to the user terminal device when receiving the distribution request including information on the viewpoint selected by a user from the user terminal device.

According to the present disclosure, it is possible to efficiently generate various videos matching diverse demands of the user by cutting out the regions respectively corresponding to the plurality of viewpoints from the captured video and generating the plurality of viewpoints different in viewpoint. The user can view the video matching his/her demand by selecting the viewpoint by the user.

### BRIEF DESCRIPTION OF DRAWINGS

FIG. 1 is an overall configuration diagram of a video distribution system according to a first embodiment.

FIG. 2 is an explanatory view illustrating a disposition status of cameras 1.

FIG. 3 is a block diagram illustrating schematic configurations of video processing computer 4 and video distribution server 6.

FIG. 4A is an explanatory view illustrating an outline of an acquisition process of a person frame performed by video processing computer 4.

FIG. 4B is an explanatory view illustrating an outline of a setting process of a cutout region performed by video processing computer 4.

FIG. 4C is an explanatory view illustrating an outline of an acquisition process of a cutout image performed by video processing computer 4.

FIG. 5 is a block diagram illustrating a schematic configuration of user terminal 2.

FIG. 6 is an explanatory view illustrating an accumulation status of a captured video in captured video storage 3.

FIG. 7 is an explanatory diagram illustrating an accumulation status of a distribution video in distribution video storage 5.

FIG. 8 is an explanatory diagram illustrating a change status of a screen displayed on user terminal 2.

FIG. 9A is an explanatory view illustrating a login screen displayed on user terminal 2.

FIG. 9B is an explanatory view illustrating an event selection screen displayed on user terminal 2.

FIG. 9C is an explanatory view illustrating a person selection screen displayed on user terminal 2.

FIG. 9D is an explanatory view illustrating a reproduction screen displayed on user terminal 2.

FIG. 10A is an explanatory view illustrating a zoom setting screen displayed on user terminal 2.

FIG. 10B is an explanatory view illustrating a capturing angle setting screen displayed on user terminal 2.

FIG. 10C is an explanatory view illustrating an attention portion setting screen displayed on user terminal 2.

FIG. 10D is an explanatory view illustrating a target person setting screen displayed on user terminal 2.

FIG. 11 is a sequence diagram illustrating operation procedures of video distribution server 6 and user terminal 2.

FIG. 12 is a block diagram illustrating a video distribution system according to a second embodiment.

### DESCRIPTION OF EMBODIMENTS

In order to solve the problem, a first invention has a configuration of a video distribution system of the present disclosure that generates a distribution video from a captured video obtained by capturing an event venue and distributes the distribution video to a user terminal device via a network, the system including: a camera that is installed at a predetermined position of the event venue and captures the event venue in a predetermined direction; a captured video storage that accumulates the captured video output from the camera; a video processing computer that cuts out regions, respectively corresponding to a plurality of viewpoints with respect to a subject from the captured video, and generates a plurality of distribution videos different in viewpoint; and a video distribution server that distributes the distribution video corresponding to a distribution request to the user terminal device when receiving the distribution request including information on the viewpoint selected by a user from the user terminal device.

According to the configuration, it is possible to efficiently generate various videos matching diverse demands of the user by cutting out the regions respectively corresponding to the plurality of viewpoints from the captured video and generating a plurality of distribution videos different in viewpoint. The user can view the video matching his/her demand by selecting the viewpoint by the user.

A second invention has a configuration that the video processing computer detects a person from the captured video, and generates the plurality of distribution videos different in target person as the viewpoints based on a result of the person detection.

According to the configuration, when the user selects the target person as the viewpoint, it is possible to view a video in which a person to which the user attends is mainly reflected.

A third invention has a configuration that a plurality of the cameras are installed at different positions in the event venue, and the video processing computer generates the plurality of distribution videos different in capturing angle as the viewpoints from the captured video of the plurality of respective cameras.

According to the configuration, when the user selects the capturing angle as the viewpoint, the user can view videos captured from various angles.

A fourth invention has a configuration that the video processing computer generates the plurality of distribution videos different in apparent zoom magnification by changing a size of the region cut out from the captured video.

According to the configuration, the user can view videos different in zoom magnification.

A fifth invention has a configuration that the video processing computer generates the plurality of distribution videos different in attention portion of the subject as the viewpoint.

According to the configuration, the user can view the video in which the attention portion is mainly reflected by selecting the attention portion of the subject as the viewpoint by the user.

A sixth invention has a configuration that the attention portion is at least one of a whole body, a face, a hand, and a feet of a person, and a musical instrument played by the person.

According to the configuration, the user can view an image in which the whole body, the face, the hand, and the feet of the person, and the musical instrument played by the person are reflected.

A seventh invention has a configuration that at a time of starting distribution, during distribution of the distribution video in response to a first distribution request transmitted from the user terminal device, when a second distribution request including information on the viewpoint selected by the user is received, the video distribution server starts preparation for distribution of the distribution video corresponding to the second distribution request, and when the preparation for distribution is completed, the video distribution server starts distribution of the distribution video corresponding to the second distribution request.

According to the configuration, while the user views the video on the user terminal device, it is possible to switch the video to another video different in viewpoint.

An eighth invention has a configuration of a user terminal device of the present disclosure that receives a distribution video distributed from a video distribution device via a network and displays the distribution video, the device including: an operation input unit that performs an operation of selecting an event desired to be viewed and a viewpoint with respect to a subject by a user; a transmitter that transmits a distribution request including information on the event and the viewpoint which are selected by the user to the video distribution device; a receiver that receives the distribution video corresponding to the distribution request distributed from the video distribution device; and a processor that controls reproduction of the received distribution video and displays the distribution video on a video display unit.

According to the configuration, similar to the first invention, it is possible to efficiently generate various videos matching diverse demands of the user and to view the video matching the demand of the user his/herself.

A ninth invention has a configuration of a video distribution method of causing an information processing device to perform a process of generating a distribution video from a captured video obtained by capturing an event venue and distributing the distribution video to a user terminal device via a network, the method including: cutting out regions respectively corresponding to a plurality of viewpoints with respect to a subject from the captured video, and generating a plurality of distribution videos different in viewpoint; and distributing the distribution video corresponding to a distribution request to the user terminal device when receiving the distribution request including information on the viewpoint selected by the user from the user terminal device.

According to the configuration, similar to the first invention, it is possible to efficiently generate various videos matching diverse demands of the user and to view the video matching the demand of the user his/herself.

Hereinafter, embodiments will be described with reference to the drawings.

### FIRST EMBODIMENT

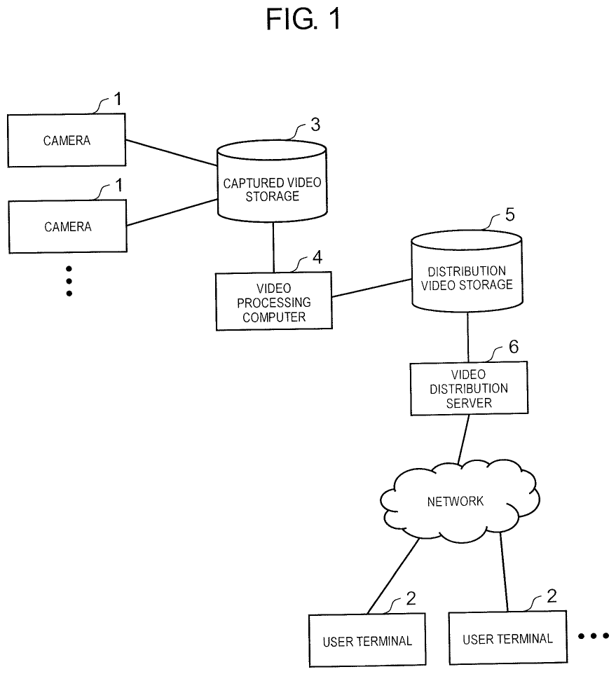

FIG. 1 is an overall configuration diagram of a video distribution system according to a first embodiment.

The video distribution system generates a distribution video from a captured video obtained by capturing a concert venue (event venue) by camera 1 and distributes the distribution video to user terminal 2 (user terminal device) via a network, and includes camera 1, captured video storage 3, video processing computer 4, distribution video storage 5, video distribution server 6, and user terminal 2.

A plurality of cameras 1 are installed in the concert venue. Each camera 1 is connected to captured video storage 3. The captured video may be stored in captured video storage 3 on the network, or may be locally stored in the capturing venue using an optical disk, a portable HDD, or the like.

User terminal 2 is a tablet terminal, a smartphone, a PC, or the like, and is connected to video distribution server 6 via a network.

Captured video storage 3 accumulates captured videos output from the plurality of cameras 1.

Video processing computer 4 performs a video process with respect to the captured video accumulated in captured video storage 3 to generate a distribution video. The video process performed by video processing computer 4 is to automate the process of generating the distribution video, and this can eliminate a need for editor's work, thereby reducing an editing cost. Video processing computer 4 is loaded with editing software for the distribution video, and can confirm or correct the generated distribution video.

Distribution video storage 5 accumulates the distribution video output from video processing computer 4. In the present embodiment, store distribution is performed, the distribution video generated by video processing computer 4 is accumulated in distribution video storage 5, and after the concert is completed, the distribution video accumulated in distribution video storage 5 is distributed to user terminal 2.

In response to a distribution request from user terminal 2, video distribution server 6 performs streaming distribution in which data of the distribution video accumulated in distribution video storage 5 is sequentially distributed to user terminal 2.

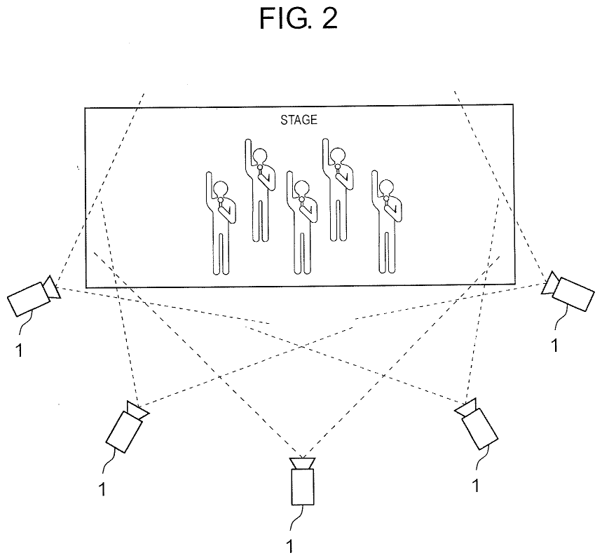

Next, a disposition status of cameras 1 will be described. FIG. 2 is an explanatory view illustrating the disposition status of cameras 1.

Each camera 1 is installed at a predetermined position in the concert venue, and the installation position is fixed (fixed point capturing). Each camera 1 is set to capture the stage from a predetermined direction, and the capturing angle (capturing direction) is also fixed. In each camera 1, wide-angle capturing is performed so that the entire stage can be substantially captured, and thereby a person moving on the stage can be captured by each camera 1 without omission. In each camera 1, capturing with high resolution (for example, 4K or more) is performed, thereby enabling a video with high definition to be distributed even when software zoom is performed. A stereo image process can be performed using the captured video by two cameras set in advance among respective cameras 1, and 3D distribution video can also be created.

Respective cameras 1 are installed at different positions so as to surround the stage. In the example illustrated in FIG. 2, cameras 1 are installed at five points of front, left, leftmost, right, and rightmost. With the five cameras 1, the persons on the stage are captured from five directions, and the capturing angles differ in five steps, that is, the videos captured from the front, oblique left, left, oblique right, and right directions can be obtained.

As described above, in the present embodiment, camera 1 is installed at a predetermined position in the event venue, and camera 1 constantly captures the event venue in a predetermined direction, and thereby a need for a cameraman is eliminated and the capturing cost can be reduced.

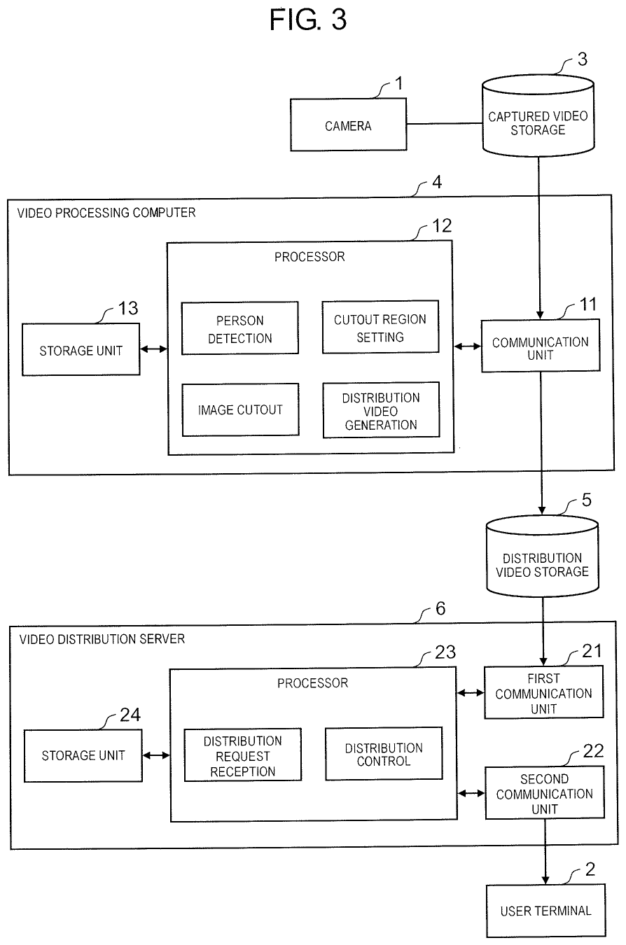

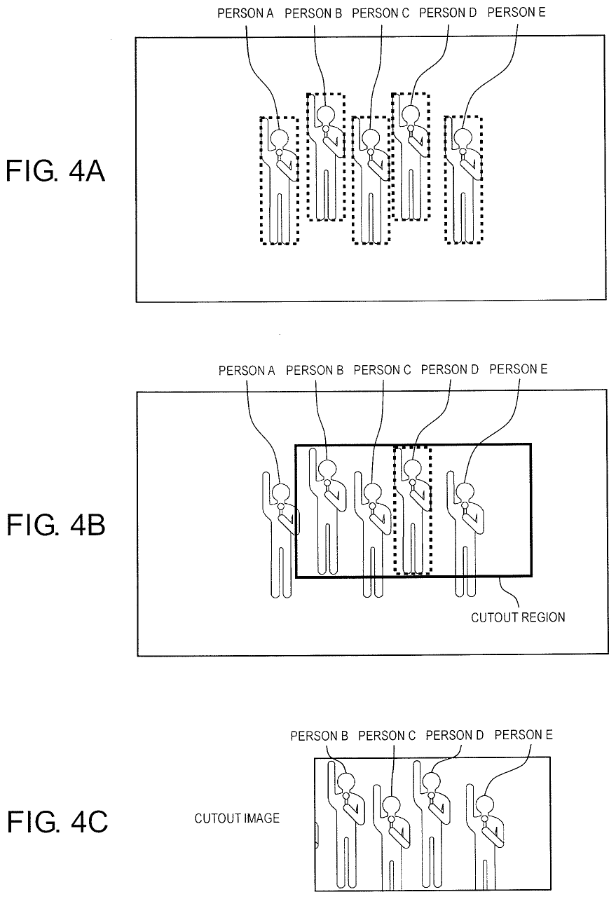

Next, schematic configurations of video processing computer 4 and video distribution server 6 will be described. FIG. 3 is a block diagram illustrating schematic configurations of video processing computer 4 and video distribution server 6. FIGS. 4A, 4B, and 4C are explanatory views illustrating an outline of a process by video processing computer 4.

Video processing computer 4 includes communication unit 11, processor 12, and storage unit 13.

Communication unit 11 communicates with captured video storage 3 and distribution video storage 5, receives the captured video transmitted from captured video storage 3, and transmits the distribution video generated by processor 12 to distribution video storage 5.

Storage unit 13 stores the captured video or the like received from captured video storage 3. Storage unit 13 also stores a program to be executed by processor 12.

Processor 12 executes various processes by executing programs stored in storage unit 13. In the present embodiment, each of processes of person detection, cutout region setting, image cutout, and distribution video generation is performed.

In the person detection process, a person (moving object) is detected from each frame of the captured video, and position information on a person region in each frame is acquired. In this case, as illustrated to FIG. 4A, the person frame surrounding a person is acquired.

In the cutout region setting process, a position and a size of the region cut out from the captured video are set based on the position information on the person region acquired in the human detection process. In the present embodiment, a distribution video in which a person detected from a captured video is reflected at a center is generated for each person, and the position of the cutout region is set so that the center of the person region (person frame) becomes the center of the cutout region.

In the present embodiment, so-called software zoom is performed, the subject is zoomed in and displayed in large and by reducing the cutout region, and the subject is zoomed out and displayed in small by enlarging the cutout region. Therefore, in the present embodiment, the size of the cutout region is set in accordance with the zoom magnification.

In the present embodiment, regions respectively corresponding to a plurality of viewpoints with respect to the subject are cut out from the captured video to generate a plurality of distribution videos different in viewpoint, and in particular, to generate a plurality of distribution videos different in attention portion of the persons as the viewpoint. Specifically, a distribution video in which the whole body, the face, the hand, and the feet of the person, and the musical instrument played by the person are at the center is generated, and the position of the cutout region is set so that the center of the attention portion becomes the center of the cutout region.

The example illustrated in FIGS. 4A, 4B, and 4C is a case of generating a distribution video related to person D among five persons A to E reflected in the captured image, and as illustrated in FIG. 4B, a center of the person frame of person D is set at the center of the cutout region, and as illustrated in FIG. 4C, a cutout image in which person D is reflected at the center is obtained.

Here, in a case where the attention portion is the whole body of the person, the center of the person region (person frame) may be set at the center of the cutout region.

In a case where the attention portion is the face, an upper region of the person region may be set as the region of the face and the center of the region may be set at the center of the cutout region. A Ω shape formed by the head and the shoulder may be detected, the head region may be specified based on the Ω shape, and the center of the region may be set at the center of the cutout region.

In a case where the attention portion is the hand, the hand may be detected for the person region as a target and the center of the hand region may be set at the center of the cutout region. A lower region of the head region specified by the Ω shape may be set as the hand region, and the center of the region may be set at the center of the cutout region.

In a case where the attention portion is the foot, the foot may be detected for the person region as a target, and the center of the foot region may be set at the center of the cutout region. A lower region of the person region may be set as the foot region, and the center of the region may be set at the center of the cutout region.

In a case where the attention portion is the musical instrument, the musical instrument may be detected for a periphery of the hand region as a target, and the center of the musical instrument region may be set at the center of the cutout region. In the detection of the musical instrument, the musical instrument may be detected paying attention to a shape and a color thereof.

In the present embodiment, the attention portions are the whole body, the face, the hand, and the feet of the person, and the musical instrument, but the upper body or the lower body of the person may be the attention portion.

In the image cutout process, an image (cutout image) of the cutout region is cut out from the captured video based on the position and the size of the cutout region set in the cutout region setting process.

In the distribution video generation process. a distribution video is generated based on the cutout image acquired in the image cutout process. In this case, the distribution video is generated based on the specification of video distribution and, for example, resampling is performed by the resolution (for example, 2K) of the distribution video.

Video distribution server 6 includes first communication unit 21, second communication unit 22, processor 23, and storage unit 24.

First communication unit 21 communicates with distribution video storage 5 and receives the distribution video transmitted from distribution video storage 5.

Second communication unit 22 communicates with user terminal 2, receives a distribution request transmitted from user terminal 2, and transmits the distribution video to user terminal 2.

Storage unit 24 stores the distribution video or the like received from distribution video storage 5. Storage unit 24 stores a program to be executed by processor 23.

Processor 23 executes programs stored in storage unit 24 to execute various processes. In the present embodiment, each process of distribution request reception and distribution control is performed.

In the distribution request reception process, a distribution request transmitted from user terminal 2 and received by second communication unit 22 is received.

In the distribution control process, in response to the distribution request received in the distribution request reception process, the distribution video corresponding to the distribution request, that is, the distribution video corresponding to the viewpoint selected by the user is acquired from distribution video storage 5, and streaming distribution, in which distribution video data is sequentially transmitted to user terminal 2, is controlled.

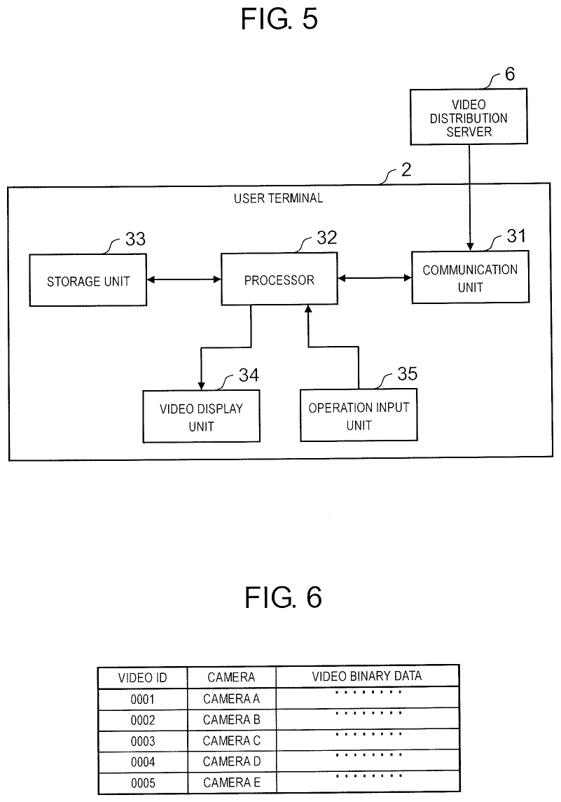

Next, a schematic configuration of user terminal 2 will be described. FIG. 5 is a block diagram illustrating a schematic configuration of user terminal 2.

User terminal 2 includes communication unit 31, processor 32, storage unit 33, video display unit 34, and operation input unit 35.

Communication unit 31 communicates with video distribution server 6, transmits a distribution request to video distribution server 6, and receives the distribution video transmitted from video distribution server 6.

Storage unit 33 stores the distribution video received from video distribution server 6. Storage unit 33 stores a program to be executed by processor 32.

Video display unit 34 is configured of a liquid crystal display panel or the like. Operation input unit 35 is configured of a touch panel, a mouse, or the like. Video display unit 34 and operation input unit 35 can be configured of a touch panel display.

Processor 32 performs various processes by executing programs stored in storage unit 33. In the present embodiment, the distribution request is transmitted from communication unit 31 to video distribution server 6 based on an operation of the user in operation input unit 35. The reproduction of the distribution video received by communication unit 31 is controlled, and the distribution video is displayed on video display unit 34.

In video distribution server 6, an audio is distributed together with the video, and user terminal 2 includes an audio output unit (not illustrated) configured of a speaker or the like, and in the audio output unit, the audio distributed from video distribution server 6 is output.

Here, in the present embodiment, when video distribution server 6 is caused to start video distribution, a first distribution request is transmitted from user terminal 2 to video distribution server 6 in accordance with the operation of the user, and a distribution video corresponding to the first distribution request is distributed from video distribution server 6 to user terminal 2. In the present embodiment, when starting the distribution, the user can select a person as a viewpoint, and the first distribution request including the selection information is transmitted from user terminal 2 to video distribution server 6.

In the present embodiment, a second distribution request is transmitted from user terminal 2 to video distribution server 6 in response to an operation of the user for selecting the viewpoint during the video distribution, and the distribution video corresponds to the second distribution request, that is, the distribution video corresponding to the viewpoint selected by the user is distributed from video distribution server 6 to user terminal 2. In the present embodiment, as the viewpoint, the capturing angle, the attention portion (full body, face, hand, feet, or musical instrument), and the target person can be selected, and the second distribution request including the selection information is transmitted from user terminal 2 to video distribution server 6. As a result, it is possible to switch the video to another video different in viewpoint at an arbitrary timing during the video distribution.

Next, the accumulation status of the captured video in captured video storage 3 will be described. FIG. 6 is an explanatory view illustrating the accumulation status of the captured video in captured video storage 3.

In the present embodiment, the captured video output from each camera 1 is accumulated in captured video storage 3. In captured video storage 3, a video ID (video identification information) with a serial number or the like is added to the captured video (video binary data), and the captured video is managed based on the video ID. In captured video storage 3, the captured video is managed based on a camera ID (camera identification information) of camera 1 of the capturing source which is attribute information of the captured video.

Although the example illustrated in FIG. 6 illustrates the captured video of one event, captured video storage 3 can accumulate the captured video for each of a plurality of events different in the artist, the date and time of the event, and the venue. In this case, a different video ID may be given to a captured video different in event, and the captured video may be managed based on a name of the event (event identification information).

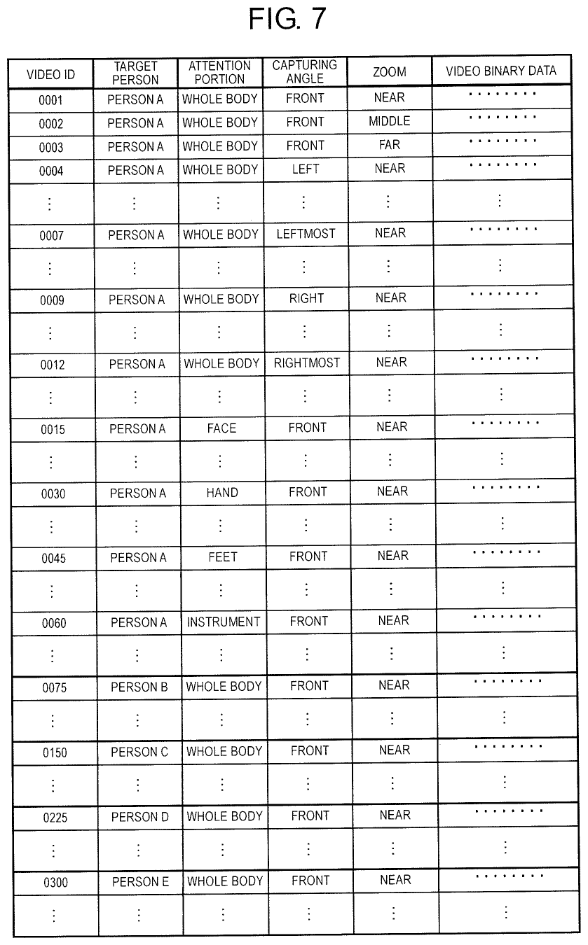

Next, the accumulation status of the distribution video in distribution video storage 5 will be described. FIG. 7 is an explanatory diagram illustrating the accumulation status of the distribution video in distribution video storage 5.

In video processing computer 4, a plurality of distribution videos different in viewpoint with respect to the subject are generated, and the plurality of distribution videos are accumulated in distribution video storage 5. In distribution video storage 5, the video ID (video identification information) with a serial number or the like is given to the distribution video (video binary data), and the distribution video is managed based on the video ID. In distribution video storage 5, the distribution video is managed based on the viewpoint (target person, attention portion, or capturing angle) and the zoom magnification, which are the attribute information of the distribution video.

In the example illustrated in FIG. 7, there are five target persons (person A to person E), five attention portions (full body, face, hand, feet, and musical instrument), five capturing angles (front, oblique left, left, oblique right, and right), and three zooms (near, middle and far), and a total of 375 distribution videos are accumulated in distribution video storage 5.

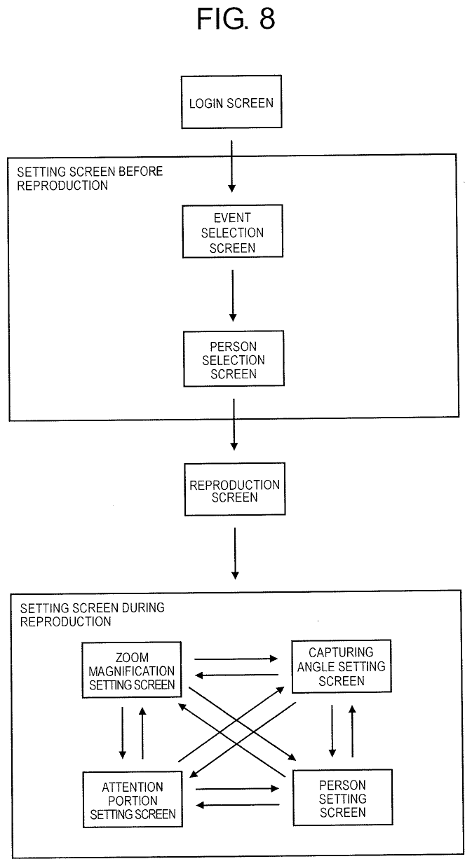

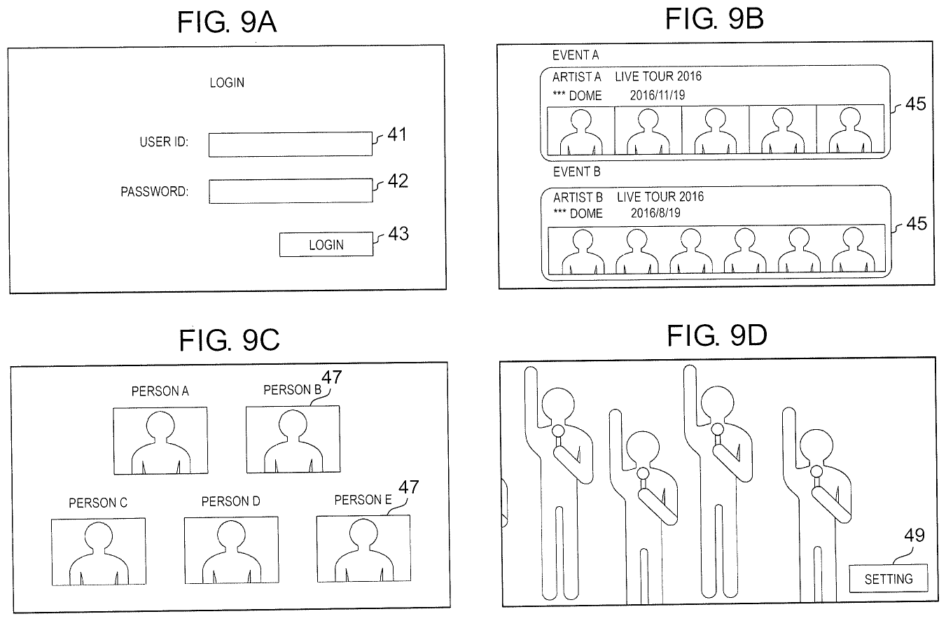

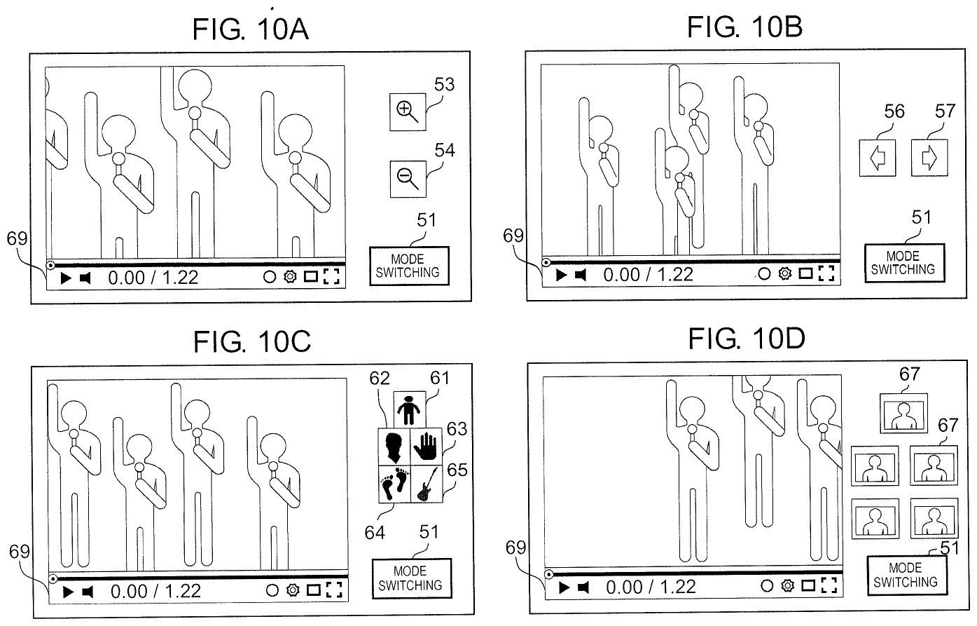

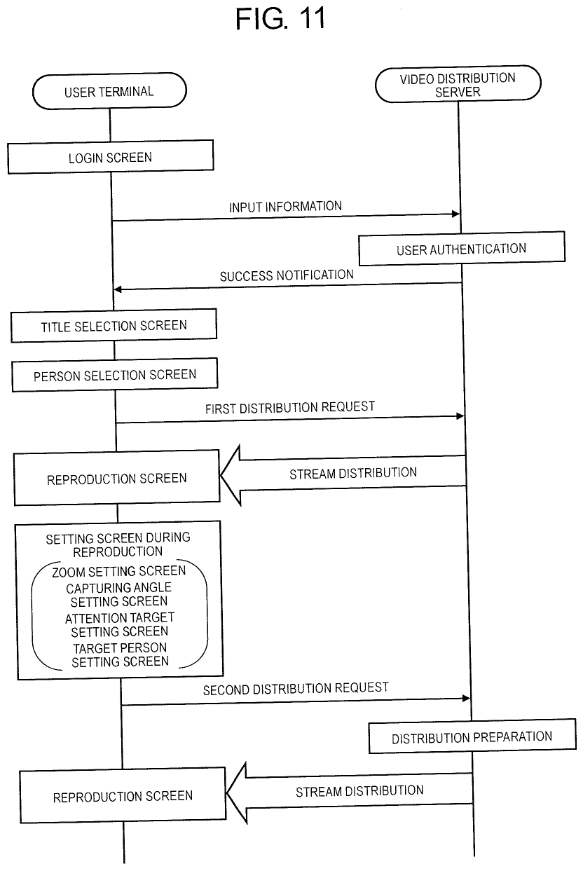

Next, the screen displayed on user terminal 2 will be described. FIG. 8 is an explanatory diagram illustrating a change status of a screen displayed on user terminal 2. FIGS. 9A, 9B, 9C, 9D, 10A, 10B, 10C, and 10D are explanatory views illustrating the screen displayed on user terminal 2. FIG. 11 is a sequence diagram illustrating operation procedures of video distribution server 6 and user terminal 2.

As illustrated in FIG. 8, in user terminal 2, when an application for viewing a distribution content is activated, first, a login screen is displayed. On the login screen, as illustrated in FIG. 9A, user ID and password input units 41 and 42 are provided. When the user inputs a user ID and a password to input units 41 and 42 on the login screen and operates login button 43, as illustrated in FIG. 11, input information is transmitted to video distribution server 6.

In video distribution server 6, user authentication is performed based on the input information, and when the user authentication is successful, a success notification for permitting use is transmitted to user terminal 2.

In user terminal 2, when the success notification is received from video distribution server 6, as illustrated in FIG. 8, the screen changes to an event selection screen.

As illustrated in FIG. 9B, in the event selection screen, event selection units 45 for each event that can be viewed by the user are provided. When the user operates event selection unit 45 of an event for which viewing is desired on the event selection screen, as illustrated in FIG. 8, the screen changes to a person selection screen.

On the person selection screen, as illustrated in FIG. 9C. thumbnails 47 for respective persons (performers) are displayed. When the user selects thumbnail 47 of a favorite person on the person selection screen, as illustrated in FIG. 11, a first distribution request is transmitted from user terminal 2 to video distribution server 6. The first distribution request includes information on the event and the person selected by the user.

In video distribution server 6, when the first distribution request from user terminal 2 is received, the distribution video corresponding to the first distribution request, that is, the distribution video corresponding to the event and the person selected by the user is acquired from distribution video storage 5, and a stream distribution for sequentially transmitting data of the distribution video to user terminal 2 is started.

In user terminal 2, when the stream distribution is started by video distribution server 6, the screen changes to the reproduction screen.

On the reproduction screen, as illustrated in FIG. 9D, the video of the event selected by the user is displayed on the entire screen. On the reproduction screen, a video in which a person selected by the user is reflected at the center is displayed, and the user can view a video of a favorite person.

“Setting” button 49 is provided on the reproduction screen. When the user operates button 49, as illustrated in FIG. 8, the screen changes to the reproduction setting screen. The reproduction setting screen includes a zoom setting screen illustrated in FIG. 10A, a capturing angle setting screen illustrated in FIG. 10B, an attention portion setting screen illustrated in FIG. 10C, and a target person setting screen illustrated in FIG. 10D.

On these setting screens during the reproduction, as illustrated in FIGS. 10A, 10B, 10C, and 10D, “mode switching” button 51 is provided. When the user operates button 51, a pull-down menu (not illustrated) is displayed, and it is possible to change the screen to another setting screen during the reproduction by selecting the setting mode (zoom magnification, capturing angle, attention portion, or target person) in the pull-down menu.

As illustrated in FIG. 10A, the zoom setting screen is provided with zoom-in and zoom-out buttons 53 and 54. When zoom-in button 53 is operated, the zoom-in is provided to be close to the subject, that is, the zoom magnification is high and the subject is largely displayed. When zoom-out button 54 is operated, the zoom-out is provided to be away from the subject, that is, the zoom magnification is low and the subject of a wide range is displayed. In the present embodiment, the zoom magnification can be adjusted in three stages (near, middle, and far).

As illustrated in FIG. 10B, the capturing angle setting screen is provided with left and right angle adjustment buttons 56 and 57. When left angle adjustment button 56 is operated, the capturing angle is shifted to the left by one, that is, switched to the video of camera 1 of the left by one. When right angle adjustment button 57 is operated, the capturing angle is shifted to the right by one, that is, switched to the video of camera 1 of the right by one. In the present embodiment, five cameras 1 are installed, and the capturing angle can be adjusted in five steps (front, oblique left, left, oblique right, and right).

As illustrated in FIG. 10C, the attention portion setting screen is provided with icons 61 to 65 for respective attention portions (whole body, face, hand, feet, and musical instrument). The attention portions are set by operating icons 61 to 65, and a video centered on the attention portion of the target person is displayed.

Here, when icon 61 of the whole body is operated, a video, in which the whole body (entire person) of the target person is reflected, is displayed. When face icon 62 is operated, a video centered on the face of the target person is displayed. When hand icon 63 is operated, a video centered on the hand of the target person is displayed. When foot icon 64 is operated, a video centered on the foot of the target person is displayed. When musical instrument icon 65 is operated, a video centered on the musical instrument being played by the target person is displayed.

As described above, in the present embodiment, since the attention portion of the target person can be changed, it is possible to observe the movement of the whole body or observe the step of the foot in detail, for example, when the person is dancing, and to observe fingering in detail when a person is playing the musical instrument.

As illustrated in FIG. 10D, thumbnails 67 for respective persons are displayed on the target person setting screen. When a person is selected by operating thumbnail 67, the selected person is set as a target person, and a video, in which the target person is reflected at the center, is displayed.

Each of these reproduction setting screens (zoom magnification setting screen, capturing angle setting screen, attention portion setting screen, and target person setting screen) is provided with reproduction operation unit 69. Reproduction operation unit 69 can perform operations such as start and stop of the reproduction, adjustment of a sound volume, and full screen display.

As described above, in the reproduction setting screens (zoom magnification setting screen, capturing angle setting screen, attention portion setting screen, and target person setting screen), when an operation for setting the zoom magnification and the viewpoint (capturing angle, attention portion, and target person) is performed, as illustrated in FIG. 11, the second distribution request is transmitted from user terminal 2 to video distribution server 6. The second distribution request includes information on the zoom magnification and the viewpoint (capturing angle, attention portion, and target person) set by the user.

When video distribution server 6 receives the second distribution request from user terminal 2, the distribution video corresponding to the second distribution request, that is, the distribution video corresponding to the zoom magnification and the viewpoint (capturing angle, attention portion, and target person) set by the user is acquired from distribution video storage 5 to start preparation for the stream distribution of the distribution video. When the preparation for the stream distribution is completed, stream distribution of a new distribution video is started, and in user terminal 2, the video displayed on the reproduction screen is switched to a new video based on the zoom magnification and the viewpoint set by the user.

As described above, in the present embodiment, the user can switch the video to another video different in viewpoint by performing an operation to change the viewpoint by the user while the user views the video on user terminal 2, and the user can view the video matching his/her demand.

### SECOND EMBODIMENT

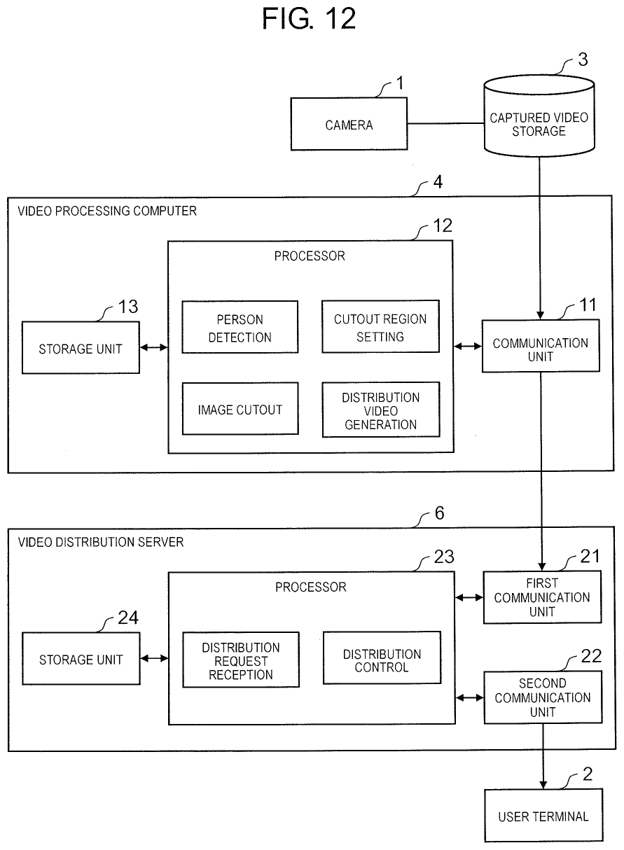

Next, a second embodiment will be described. Points not particularly mentioned here are the same as those of the above embodiment. FIG. 12 is a block diagram illustrating a video distribution system according to the second embodiment.

In the first embodiment (see FIG. 3), the store distribution, that is, the distribution video generated by video processing computer 4 is accumulated in distribution video storage 5, and the distribution video accumulated in distribution video storage 5 is distributed to user terminal 2 according to the distribution request from user terminal 2. However, in the present embodiment, live distribution, that is, a distribution video generated by video processing computer 4 is distributed to user terminal 2, and distribution video storage 5 provided in the first embodiment is not provided.

Although the schematic configurations of video processing computer 4 and video distribution server 6 are the same as those in the first embodiment, video processing computer 4 generates all the distribution videos regardless of the distribution request from user terminal 2, and video distribution server 6 selects the distribution video corresponding to the distribution request, that is, the distribution video corresponding to the viewpoint selected by the user, from the distribution video output from video processing computer 4 in response to the distribution request from user terminal 2 to distribute the distribution video to user terminal 2.

As described above, the embodiments are described as examples of the technology disclosed in the present application. However, the technology in the present disclosure is not limited to the embodiments, and can be applied to embodiments in which changes, replacements, additions, omissions, and the like are performed. It is also possible to combine respective configuration components explained in the above embodiments to set those as a new embodiment.

For example, in the above embodiments, the video processing computer (video processing device) and the video distribution server (video distribution device) are provided, but the video processing computer and the video distribution server may be configured of one information processing device.

Although the captured video storage and the distribution video storage are provided, the captured video storage and the distribution video storage may be configured of one storage device.

In the above embodiments, although an example in which the subject of the video is a person is described, the subject of the video is not limited to the person, and may be a video in which a moving object other than the person such as an animal is the subject.

### INDUSTRIAL APPLICABILITY

The video distribution system, the user terminal device, and the video distribution method according to the present disclosure have the effects that various videos matching diverse demands of the user can be efficiently generated and a video that matches the needs of the user his/herself can be viewed, and are useful as a video distribution system and a video distribution method for distributing the distribution video to the user terminal device via a network by generating the distribution video from the captured video obtained by capturing the event venue, and a user terminal device that displays the distribution video by receiving the distribution video distributed from the video distribution device via a network.

### REFERENCE MARKS IN THE DRAWINGS

1 CAMERA

2 USER TERMINAL (USER TERMINAL DEVICE)

3 CAPTURED VIDEO STORAGE

4 VIDEO PROCESSING COMPUTER

5 DISTRIBUTION VIDEO STORAGE

6 VIDEO DISTRIBUTION SERVER

31 COMMUNICATION UNIT (TRANSMITTER, RECEIVER)

32 PROCESSOR

34 VIDEO DISPLAY UNIT

35 OPERATION INPUT UNIT

1. A video distribution system that generates a distribution video from a captured video obtained by capturing an event venue and distributes the distribution video to a user terminal device via a network, the system comprising:
a camera that is installed at a predetermined position of the event venue and captures the event venue in a predetermined direction;
a captured video storage that accumulates the captured video output from the camera;
a video processing computer that cuts out regions respectively corresponding to a plurality of viewpoints with respect to a subject from the captured video, and generates a plurality of distribution videos different in viewpoint; and
a video distribution server that distributes the distribution video corresponding to a distribution request to the user terminal device when receiving the distribution request including information on the viewpoint selected by a user from the user terminal device.

2. The video distribution system of claim 1,
wherein the video processing computer detects a person from the captured video, and generates the plurality of distribution videos different in target person as the viewpoint based on a result of the person detection.

3. The video distribution system of claim 1,
wherein a plurality of the cameras are installed at different positions in the event venue, and
wherein the video processing computer generates the plurality of distribution videos different in capturing angle as the viewpoint from the captured video of each of the plurality of cameras.

4. The video distribution system of claim 1,
wherein the video processing computer generates the plurality of distribution videos different in apparent zoom magnification by changing a size of the region cut out from the captured video.

5. The video distribution system of claim 1,
wherein the video processing computer generates the plurality of distribution videos different in attention portion of the subject as the viewpoint.

6. The video distribution system of claim 5,
wherein the attention portion is at least one of a whole body, a face, a hand, and a feet of a person, and a musical instrument played by the person.

7. The video distribution system of claim 1,
wherein at a time of starting distribution, during distribution of the distribution video in response to a first distribution request transmitted from the user terminal device, when a second distribution request including information on the viewpoint selected by the user is received, the video distribution server starts preparation for distribution of the distribution video corresponding to the second distribution request, and when the preparation for distribution is completed, the video distribution server starts distribution of the distribution video corresponding to the second distribution request.

8. A user terminal device that receives a distribution video distributed from a video distribution device via a network and displays the distribution video, the device comprising:
an operation input unit that performs an operation of selecting an event desired to be viewed and a viewpoint with respect to a subject by a user;
a transmitter that transmits a distribution request including information on the event and the viewpoint which are selected by the user to the video distribution device;
a receiver that receives the distribution video corresponding to the distribution request distributed from the video distribution device; and
a processor that controls reproduction of the received distribution video and displays the distribution video on a video display unit.

9. A video distribution method of causing an information processing device to perform a process of generating a distribution video from a captured video obtained by capturing an event venue and distributing the distribution video to a user terminal device via a network, the method comprising:
cutting out regions respectively corresponding to a plurality of viewpoints with respect to a subject from the captured video, and generating a plurality of distribution videos different in viewpoint; and
distributing the distribution video corresponding to a distribution request to the user terminal device when receiving the distribution request including information on the viewpoint selected by a user from the user terminal device.
